(19) United States
(12) Patent Application Publication
(10) Pub. No.: US 2009/0004424 A1
(43) Pub. Date: Jan. 1, 2009

(54) Bi-Oriented Polypropylene Film Comprising Tear Orientation, a Process of Preparing Said Film and an Article Comprising it

(76) Inventors: Daniel De Almeida, Votorantim (BR); Rosicarla Vectirans Vieira, Votorantim (BR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/813,106

(22) PCT Filed: Dec. 28, 2005
(86) PCT No.: PCT/BR2005/000261

§ 371 Date: Apr. 7, 2008

(30) Foreign Application Priority Data
Dec. 29, 2004 (BR) PI0406071-7

(51) Int. Cl. B32B 27/32; C08J 5/18

(52) U.S. Cl. 428/43; 428/523; 264/210.7

(57) ABSTRACT

The present invention relates to a bi-oriented polypropylene film comprising tear orientation in the transverse direction. By virtue of this achieved property, this film is suitable for making packages, especially in the food and paper sectors, since it provides easy opening of the package, besides preventing damages to the packed product or even to the opened package itself. Further, the invention relates to a process for preparing said film and article comprising the bi-oriented polypropylene film having a tear orientation.

This application claims priority of Brazilian patent application no PI 0406071-7 filed on Dec. 29, 2004 the disclosure thereof being hereby incorporated by reference.

### FIELD OF THE INVENTION

The present invention relates to a polypropylene polymer film treated by the stretching process for stretching in both transverse and longitudinal directions. In addition, the stretching parameters are such that tearing the film takes place in an oriented manner at any point in the transverse direction, without any need to provide an accessory for orienting the tearing. By virtue of this achieved property, this film is indicated for making packages, especially in the paper and food sectors, since it enables one to open the wrapping easily, besides preventing damages to the packed product or even to the opened package itself.

The invention also relates to a process of preparing said film and to articles made from said BOPP film.

### DESCRIPTION OF THE PRIOR ART

Today, many packages for packing various products and articles are manufactured from polypropylene and especially from bi-oriented or bi-axially oriented polypropylene. Bi-oriented polypropylene is a polymer formed of propylene monomers, the chains of which are oriented, producing a film with properties of barrier, rigidity and mechanical resistance that are very superior to the physicochemical properties of polypropylene films without chain orientation. By virtue of this factor, this polymer has various applications, as for example, packages for food and other products, adhesive tapes, labels, graphic lamination, among others.

However, at present there is concern for improving the use of these packages produced from BOPP. It is known that, by virtue of the mechanical resistance of BOPP films, it is difficult to open said packages. Thus, damages to the product may occur when the package is opened. In this regard, some techniques have been developed for overcoming this drawback.

The applicant indicates, hereinafter, the relevant documents of the prior art relating to the matter of the present invention.

Document U.S. Pat. No. 5,630,308 discloses an equipment that makes alignments on the package films and thus provides control over the tearing. This alignment is obtained by using laser, which marks the line on the substrate along the whole length of the film.

On the other hand, document U.S. Pat. No. 3,909,582 describes a method of forming a line of low tear strength in layers of polymeric films obtained by using energy rays with wavelength and intensity determined as laser. These so-called “weak” lines are intended to bring about easy opening of the package.

Another document that relates to a technique for tearing a package film open is patent application WO 03/072454, which discloses a film for package that is flexible or polymeric, for example BOPP. This film has at least one tear line for this purpose with a free end, by which the user can open the package. This line is marked in the longitudinal direction along the whole film length.

And document U.S. Pat. No. 6,248,442 describes a bi-axially oriented multi-layer film, which is heat-sealable and produced from polyethylene films. This film has orientation for tearing in longitudinal direction obtained by a mechanical process that orients the chains for this purpose.

As can be seen from the description of the present invention hereinafter, no teaching of the prior art proposes different advantages in opening a package so easily, besides producing a BOPP film, having tearing orientation in such an economical way.

### SUMMARY OF THE INVENTION

An objective of the invention is to provide a bi-oriented polypropylene film having tear orientation in transverse direction.

Another objective of the invention is to provide a process of preparing the bi-oriented polypropylene film that comprises the following steps:

a—extrusion of the polypropylene;
b—casting;
c—mechanical stretching of the film in longitudinal direction; and
d—mechanical stretching of the film in transverse direction,
wherein the parameters of longitudinal mechanical stretching range from 0 to 2, and the parameters of transverse mechanical stretching range from 6 to 12.

A further objective of the present invention is to provide articles comprising the films described above.

### BRIEF DESCRIPTION OF THE DRAWINGS

The present invention will now be described in greater detail with reference to an embodiment presented in the drawings; the figures show:

FIG. 1 is an illustration of the layers of a transparent bi-oriented polypropylene film; and

FIG. 2 is an illustration of the layers of an opaque bi-oriented polypropylene film.

### DETAILED DESCRIPTION OF THE INVENTION

The present invention discloses a polypropylene polymer film treated with the stretching process in both transverse and longitudinal directions. In addition, the stretching parameters are such that the tearing of the film takes place in an oriented manner at any point of the transverse direction, without the need to provide any accessory for initiating the tearing. By virtue of this achieved property, this film is indicated for the manufacture of packages, especially in the food, non-food and tobacco sectors, since enables easy opening of the wrapping, besides preventing damages to the packed product or even to the opened package itself.

The present invention further discloses articles manufactured from said BOPP film.

The present-day packages for packing paper reams are composed of:
plastic films laminated with paper (most packages available on the market) or
laminated bi-oriented polypropylene (BOPP) films, one being opaque and the other being transparent, according to the structure indicated below.
The present invention has a number of advantages over the films of the prior art, among which the following are pointed out:
in comparison with the packages used at present in the prior art, the packages composed of two BOPP films confer greater resistance, impermeability and protection against moisture;

with these properties, the product protected inside it will also have stability and ultimately a longer shelf life;
in addition, this structure formed exclusively from polypropylene, exactly because it is formed by a single type of material, enables integral recycling of the package;
it has the capability of shaping the package;
it can be closed by heat sealing in continuous packing processes;
the BOPP films used at present for packing reams do not have an orientation of tearing for opening the package; the package tear in a disoriented manner, causing difficulties for the user;

the BOPP film of the present invention can be torn open at any point of its transverse direction; for this reason, there are a number of possibility of forming the packages;
since it is not necessary to alter the composition of the BOPP film, because the tearing orientation is provided by a mechanical process, the film of the present invention becomes more economical in comparison with those existing on the market; and
optionally, one may add an accessory that enables one to start tearing the package open, as for example, a tear tape.
   BOPP with Tearing Orientation

The bi-oriented polypropylene film of the present invention comprises a polypropylene base layer 2, which will be detailed later. Preferably, the film of the present invention comprises three layers: a first heat sealable layer 1, a polypropylene (PP) base layer 2 and a second heat sealable surface 3. The first heat sealable surface 1 is applied to one of the faces of the base layer 2, and the second heat sealable surface 3 is applied to the other face of base layer 2, resulting in a three-layer film, wherein the central layer is the polypropylene base layer 2.

These layers are explained below;

### First Heat Sealable Polymeric Surface 1

Preferably, the thickness of this layer ranges from 1.0 to 2.5 μm, preferably about 1.0 μm.

In this film layer one may use at least one polymeric material selected from ethylene/butane polypropylene terpolymer, ethene polypropylene copolymer, butene polypropylene copolymer, ethene/butene copolymer, butene polymer and combinations thereof.

In addition to the polymeric material selected from the above options, one may use additives to provide characteristics and/or properties that are not achieved with the use of polymer alone. One may use additives commonly found in polymeric compositions of the prior art. Preferably, the following are added.
Antiblocking additive such as organic and inorganic thin particles. Examples of organic particles indicated to be used as antiblocking additives are polyethylene, polyamides, polyesters, polyacrylic acid esters, polymetacrylic acid esters, among others, in addition to combinations thereof; further, examples of inorganic particles indicated to be used as antiblocking additives are talc, kaolin, silica or calcium carbonate, glass powder, among others, in addition to mixtures thereof
a slip additive such as erucamide, oleamide, stearamide, ethylene bistearamide, ethylene bissoleamide, polydimethylsyloxane, siloxane, silicone, sterayl erucamide, oleyl palmitamide and other saturated fatty amides, unsaturated fatty amides and further combinations thereof.

In a preferred embodiment, the first heat sealable polymeric surface 1 comprises:
an amount of copolymer ranging from 98% to 100% by weight, preferably about 99.7% by weight;
an amount of antiblocking additive ranging from 0% to about 1% by weight, preferably about 0.2% by weight;
an amount of sliding additive ranging from 0% to about 1% by weight, preferably about 0,1%,
   all the above amounts being based on the total weight of the composition of the first heat sealable polymeric surface 1.

Further, this surface 1 may optionally receive a treatment for anchoring adhesives, inks or varnishes, among other treatment known for polymeric films.

### Polypropylene Base Layer 2

The so-called polypropylene base layer 2 is essentially constituted by polypropylene homopolymer. Preferably, homopolymers containing a content of solubles in xylene ranging from 1.0% to 6.0%, by weight. Examples of these kinds of polypropylene homopolymer are: Standard and high crystallinity.

Like the layer described before, in addition to polypropylene, one may use additive to confer characteristics and/or properties that are not achieved with the use of polymer alone. The following additives may be used:
Antistatic additive that acts to reduce the static charge, such as dethoxylamine, esterified ethoxylamine, monosteryl glycerate, ethoxylated tertiary amine and combinations thereof. This additive is added to the composition of the polypropylene base layer 2 in an amount ranging from 0 to about 1% by weight, based on the total weight of said base layer; and
optionally, opacifying agent, if desired an opaque film (evidently this additive is only added to the composition of the base layer if one wishes it to be opaque. In the absence of this additive, the base layer will be transparent): as for example, carbonates and titanium dioxide and combinations thereof. This additive is added to the composition of the polypropylene base layer in an amount ranging 0% to about 25% by weight, based on the total weight of said the base layer 2.

In the preferred embodiment, one adds to the polypropylene base layer 2 an amount of polypropylene homopolymer ranging from about 75% to about 95% by weight, preferably about 74.8% by weight; an amount of antistatic additive ranging from 0 to about 1% by weight, preferably about 0.2% by weight; and an amount of opacifying agent ranging from 0 to 25% by weight, based on the total weight of the composition of the polypropylene base layer 2.

### Second Heat Sealable Polymeric Surface 3

Preferably, the thickness of this layer 3 ranges from 1.0 to 2.5 μm, preferably about 1.8 μm.

In this layer of the film, one may use various polymers or copolymers, such as ethene/butane polypropylene terpolymer, polybutene and combinations thereof.

Preferably, one uses a second heat sealable surface 3 as described in the Brazilian patent application filed on Dec. 20, 2005 which claims priority of Brazilian patent application number PI 0405944-1 of the same applicant, the former entitled “A Heat-Sealable Bi-Oriented Polypropylene Film, Use of This Film and an Article Prepared From Said Film”.

### Constitution of the Bi-Oriented Polypropylene Film Comprising Tear Orientation

As can be seen from the above teachings, one of the preferred embodiments of the film of the present invention comprises three layers: a first heat sealable surface 1, a polypropylene base layer 2 and a second heat sealable surface 3.

However, one may also prepare a bi-oriented polypropylene film having tear orientation and comprising 5 layers in the following arrangement:
first heat sealing surface 1;
an intermediate polymeric layer (not shown);
a polypropylene base layer 2;
an intermediate polymeric layer (not shown) and
a second heat sealable surface 3.

The intermediate polymeric layers comprise compositions intended to confer to said film some desired characteristic that is not achieved with the main layers.

Further, the film may comprise 5 layers, without said intermediate layers, wherein at least two of the layers described above (heat sealable surface 1, polypropylene base layer 2 and heat sealable layer 3) are present in duplicity or one of these is tripled.

### Process of Manufacturing the Bi-Oriented Polypropylene Film of the Present Invention

The process of manufacturing the BOPP film of the present invention is similar to the one known from the prior art. However, the stretching parameters used upon orientation of the polymer chains have been altered so as to achieve the tear orientation at any point of the film in the transverse direction. In short, the process of manufacturing the film in question comprises the following steps:

1-extruding the polypropylene, so that the polymer can be molten;
2-casting and cooling the polypropylene film (polypropylene base layer 2);
3-stretching the film mechanically in the longitudinal direction; this stretching promotes the orientation of the polymer chains in the direction of the machine;
4-stretching the film mechanically in the transverse direction; this stretching promotes the orientation of the chains of the polymer in the direction of the width of the film, whereby a bi-axially oriented film is obtained;
5-traction and treatment of the oriented film (heat sealable surfaces 1 and 3); and
6-winding.

The polypropylene used in step 1 of the above process is obtained by polymerizing propane, which is a product of the cracking of naphtha. As already said before, the polypropylene may be either of the Standard type or of the high-crystallinity type.

In the present invention, the steps of mechanical stretching 3 and 4 undergo alteration in their parameters. By virtue of much study and after various tests, the ideal stretching parameters were achieved in order to obtain BOPP films exhibiting physicochemical properties suitable for packages and also tear orientation, which is the main objective of the present invention.

At present, the parameters used in making BOPP films vary for the longitudinal mechanical stretching from 4.5 to 5.5, and for the transverse mechanical stretching parameters from 7 to 10.

On the other hand, the film of the present invention presents variation in the parameters for longitudinal mechanical stretching from 0 to 2.0, and for the parameters of transverse mechanical stretching from 6 to 12.

The bi-oriented polypropylene films known at present do not have tear orientation in the transverse and longitudinal directions. So, when the user tries to open the package made from this material, it tears open in a disoriented, which may damage the product packed therein.

On the other hand, a package made from the film of the present invention does not have this drawback. With the tear orientation obtained by the process described above, the tearing takes place in a substantially straight line, whereby the quality of the package is kept and the packed product is not damaged.

In an alternative embodiment, one may use a tear tape fixed to the inner surface of the film when it is shaped into a package.

Further, one may make a flap at any point of the film so as to facilitate the oriented tearing in said film for opening the package.

Moreover, one may also achieve this property of tearing in the longitudinal direction of the polypropylene film.

Further, the tear orientation achieved for the present invention may be extended for other polymeric films that exhibit properties of chain orientation similar to those of propylene.

### Preferred Embodiment

In a preferred embodiment of the present invention, two films (transparent and opaque) of the present invention present a oriented tear so as to bring about easy opening in the transverse direction, a possibility that is not offered by present-day packages. Without this tear the opening takes place in a disoriented manner. In this preferred embodiment, the films are composed as follows.

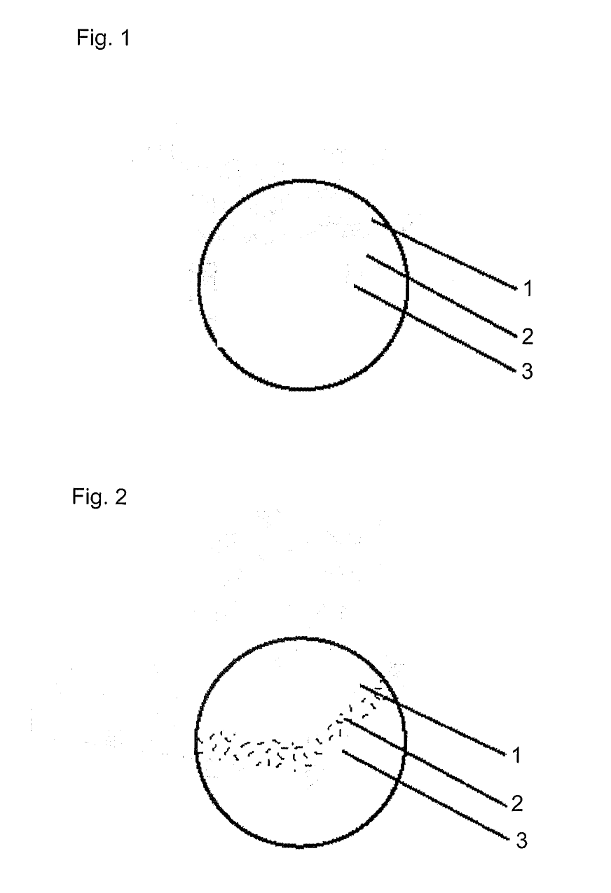

1) Transparent film (shown in FIG. 1): a bi-oriented, transparent polypropylene film having a thickness of 25 microns and being heat sealable on both faces. Preferably, it is subjected to a surface treatment (flame or corona) on one of its faces for printing and/or lamination. This film comprises a polypropylene base layer 2, a first heat sealable surface 1 applied to one of the faces of the base layer 2 and a second heat sealable surface 3 applied to the other face of the base layer 2.

2) Opaque film (shown in FIG. 2): a bi-oriented, opaque, pearlized polypropylene film, with a surface unit weight of 30 g/m², heat sealable on both faces. By preference, it is subjected to a surface treatment (flame or corona) on one of the faces for printing and/or lamination. Like the film described above, this film comprises a polypropylene base layer 2, a first heat sealable surface 1 applied to the one of the faces of the base layer 2 and a second heat sealable surface 3 applied to the other face of the base layer 2.

### Examples of Composition

The illustrative examples presented hereinafter will serve to describe the invention in a better manner, the values indicating the weight percentage of each layer.

However, the data illustrated merely refer to some embodiments of the present invention and should not be taken as being limitative of the scope of the invention. The scope of the present invention embraces other variations, being limited only by the contents of the accompanying claims, which include the possible equivalents.

### Example 1

### Transparent Bi-Oriented Polypropylene Film

A film comprising three ABA-type layers, wherein layer A is the first outer layer herein called first heat sealable surface 1, layer B is called a polypropylene base layer 2 and layer C is a second outer layer called herein the heat sealable surface 3, which has been produced by extrusion and then stretched in the longitudinal and transverse directions according to the parameters of the present invention (transversal stretching 6 to 12 and longitudinal stretching from 0 to 2). The surface 1 has a thickness of 1.0 μm and the surface 3 has 1.8 μm.

The polypropylene base layer 2 comprises 97.8% by weight of Standard polypropylene homopolymer and 0.2% by weight of antistatic additive.

The first heat sealable surface 1 comprises 99.7% by weight of ethene polypropylene copolymer, 0.2% by weight of antiblocking additive and 0.1% by weight of slip additive.

On the other hand, the second heat sealable surface 3 has been prepared in accordance with the teachings of the Brazilian patent application filed on Dec. 20, 2005 which claims priority of Brazilian patent application number PI 0405944-1 of the same applicant, the former entitled “A Heat-Sealable Bi-Oriented Polypropylene Film, Use of This Film and an Article Prepared From Said Film”.

### Example 2

### Opaque Bi-Oriented Polypropylene Film

A film comprising three ABC-type layers, wherein layer A is a first outer layer called first heat sealable surface 1, layer B is called the polypropylene base layer 2 and layer C is a second outer layer called second heat sealable surface 3, which has been produced by extrusion and then stretching in the longitudinal and transversal directions in accordance with the parameters of the present invention (transverse stretching 6 and 12 and longitudinal stretching from 0 to 2). The surface 1 has a thickness of 1.0 μm and the surface 3 has a thickness of 1.8 μm.

The polypropylene base layer 2 comprises 80% by weight of Standard polypropylene homopolymer, 0.2% by weight of antistatic and 0.1% by weight of slip additive and 19.7% by weight of opacifying agent.

The heat sealable surface 1 comprises 99.9% by weight of ethene polypropylene copolymer, 0.1% by weight of antiblocking additive.

On the other hand, the heat sealable surface 3 has been prepared in accordance with the teachings of the Brazilian patent application filed on Dec. 20, 2005 which claims priority of Brazilian patent application number PI 0405944-1 of the same applicant, the former entitled “A Heat-Sealable Bi-Oriented Polypropylene Film, Use of This Film and an Article Prepared From Said Film”.

A preferred embodiment having been described, it should be understood that the scope of the present invention embraces other possible variations, being limited only by the contents of the accompanying claims, which include the possible equivalents.

1. A bi-oriented polypropylene film characterized by comprising tear orientation in the transverse direction.

2. A bi-oriented polypropylene film according to claim 1, characterized by comprising at least a first heat sealable polymeric surface (1) and a polypropylene base layer (2).

3. A bi-oriented polypropylene film according to claim 2, characterized in that the polypropylene base layer (2) comprises at least one polypropylene homopolymer containing a content of solubles in xylene ranging from 1.0% to 6.0%, by weight and antistatic additive.

4. A bi-oriented polypropylene film according to claim 2, characterized in that the heat sealable polymeric surface (1) comprises a ethene polypropylene copolymer layer, antiblocking additive and slip additive.

5. A bi-oriented polypropylene film according to claim 1, characterized by comprising three layers.

6. A bi-oriented polypropylene film according to claim 5, characterized by comprising the polypropylene base layer (2) being the central layer, a first heat sealable polymeric surface (1) adjacent to the polypropylene base layer (2) and a second heat sealable polymeric surface (3) adjacent to the polypropylene base layer (2) and opposite to the first heat sealable polymeric surface (1).

7. A bi-oriented polypropylene film according to claim 6, characterized in that the second heat sealable polymeric surface (3) comprises a ethane/butene polypropylene terpolymer, hydrocarbonic resin and, slip and antiblocking additives.

8. A bi-oriented polypropylene film according to claim 1, characterized by comprising at least two polypropylene base layers (2).

9. A process of preparing a bi-oriented polypropylene film as defined in claim 1, characterized by comprising the following steps:
a—extrusion of the polypropylene;
b—casting;
c—longitudinal mechanical stretching of the film;
d—transverse mechanical stretching of the film;
wherein the process is characterized in that the parameters of longitudinal mechanical stretching range from 0 to 2 and the parameters of transverse mechanical stretching range from 6 to 12.

10. A process according to claim 9, characterized by comprising the additional step of;
e—traction and treatment of the oriented film.

11. A process according to claim 9, characterized by comprising the additional step of:
f-winding.

12. A bi-oriented polypropylene film characterized by being obtainable by the process as defined in claim 9.

13. An article characterized by comprising at least one bi-oriented polypropylene film as defined in claim 1.

14. An article according to claim 13, characterized by comprising two bi-oriented polypropylene films as defined in claim 1.

15. An article according to claim 13, characterized by being a package.

16. An article characterized by comprising the bi-oriented polypropylene film as defined in claim 12.

17. An article according to claim 16, characterized by being a package.
